(19) United States
(12) Patent Application Publication
(10) Pub. No.: US 2024/0313582 A1
(43) Pub. Date: Sep. 19, 2024

(54) Wireless Power Transfer Network

(71) Applicant: Huawei Digital Power Technologies Co., Ltd., Shenzhen (CN)

(72) Inventor: Daniel Gil Belo, Kista (SE)

(21) Appl. No.: 18/673,718

(22) Filed: May 24, 2024

Related U.S. Application Data
(63) Continuation of application No. PCT/EP2021/083218, filed on Nov. 26, 2021.

(51) Int. Cl. H02J 50/20; H02J 50/40; H02J 50/80

(52) U.S. Cl. CPC H02J 50/20; H02J 50/80; H02J 50/402

(57) ABSTRACT

A wireless power transfer system includes a wireless power transmitter configured to transmit a query power signal and a wireless power receiver that is in an energy depleted state that is configured to transmit a backscatter signal in response to receipt of the query power signal. The wireless power transmitter is configured to detect the backscatter signal from the wireless power receiver, determine from the backscatter signal if a wireless power delivery requirement of the wireless power receiver is met, and deliver wireless power to the wireless power receiver if the wireless power delivery requirement is met.

### CROSS-REFERENCE TO RELATED APPLICATIONS

This is a continuation of International Patent Application No. PCT/EP2021/083218 filed on Nov. 26, 2021, the disclosure of which is hereby incorporated by reference in its entirety.

### TECHNICAL FIELD

The aspects of the disclosed embodiments relate generally to far field wireless power transmission (WPT) and, more particularly to wireless power delivery to energy depleted apparatus in a wireless power transfer network (WPTN).

### BACKGROUND

In far-field WPT, to increase the power delivery and communication range, high gain antennas and beam-forming techniques are desired for long range wireless power transfer. However, for increased gain the wireless power transmitter has to know where the wireless power receiver is, or has to find the best direction to send energy to it.

Typically, the wireless power receiver apparatus to be powered can initiate a communication by its own, or it is located within the transmitter's field of view (FOV). If the wireless power receiver apparatus does not have an energy source or is not located within the wireless power transmitter's FOV due to the use of high gain antennas, detection becomes more challenging.

Backscatter signaling can be useful as a feedback mechanism in wireless power transfer systems and ultra-low power receivers. However, backscatter signaling generates a clock and/or data modulation signal within the wireless power receiver. The use of a processing unit to generate such signal uses a certain amount of power and can introduce additional delay to the scanning/detection of battery-less power receivers due to the initialization of protocols, overheads and possible signal sampling.

Thus, there is a need for improved apparatus and methods that can efficiently identify, locate and provide wireless electrical power to energy depleted wireless power receiver apparatus in a WPTN. Accordingly, it would be desirable to provide methods and apparatuses that address at least some of the problems described above.

### SUMMARY

The aspects of the disclosed embodiments are directed to a wireless power transfer system that allows the fast detection and delivery of wireless power by focusing the energy from a high gain beam-forming/beam-shaping antenna towards a battery-less wireless power receiver apparatus or a wireless power receiver apparatus with a depleted battery. This and other objectives are solved by the subject matter of the independent claims. Further advantageous embodiments can be found in the dependent claims.

According to a first aspect, the above and further objectives and advantages are obtained by a wireless power transfer system. In one embodiment, the wireless power transfer system includes a wireless power transmitter apparatus configured to transmit a query power signal (f_{QPS}) and a wireless power receiver apparatus in an energy depleted state that is configured to transmit a backscatter signal (f_{BS}) in response to receipt of f_{QPS}. The wireless power transmitter apparatus is configured to detect f_{BS} from the wireless power receiver apparatus, determine from the detected f_{BS} if a wireless power delivery requirement of the wireless power receiver apparatus is met, and deliver wireless power to the wireless power receiver apparatus if the wireless power delivery requirement is met. The aspects of the disclosed embodiments enable the detection of targets, such as battery-less wireless power receiver apparatus, or wireless power receiver apparatus that cannot initiate signaling to request wireless power.

In a possible implementation form the wireless power transmitter apparatus is configured to switch to a continuous wave (CW) mode to deliver power to the wireless power receiver apparatus. The wireless power receiver apparatus cooperates with the wireless power transmitter apparatus in order to be detectable and to allow the wireless power transmitter to find the best direction to transmit the radio frequency (RF) energy.

In a possible implementation form the wireless power transmitter apparatus is configured to transmit a backscatter carrier signal (f_{BC}). The aspects of the disclosed embodiments enable the detection of targets, such as battery-less wireless power receiver apparatus, or wireless power receiver apparatus that cannot initiate signaling to request wireless power.

In a possible implementation form the f_{QPS} includes a power signal (f_{WPT}) and a query modulation signal component (fₙ). The frequency of oscillation is related with the input RF power enabling the detection of targets, such as battery-less wireless power receiver apparatus, or wireless power receiver apparatus that cannot initiate signaling to request wireless power.

In a possible implementation form the f_{BS} comprises an f_{BC} modulated by an fₙ of the f_{QPS}. The frequency of oscillation is related with the input RF power enabling the detection of targets, such as battery-less wireless power receiver apparatus, or wireless power receiver apparatus that cannot initiate signaling to request wireless power.

In a possible implementation form the f_{QPS} is a pulse modulated signal with a specific pulse period. The frequency of oscillation is related with the input RF power enabling the detection of targets, such as battery-less wireless power receiver apparatus, or wireless power receiver apparatus that cannot initiate signaling to request wireless power.

In a possible implementation form the wireless power transmitter apparatus is configured to transmit the f_{QPS} in a plurality of directions (Dₘ). The aspects of the disclosed embodiments do not need to try every beam direction and there is no need for processing, which allows for speeding up the detection time and power delivery.

In a possible implementation form the wireless power transmitter apparatus is configured to transmit the f_{QPS} in a plurality of sub-directions (D_{m, k}). The aspects of the disclosed embodiments do not need to try every beam direction and there is no need for processing, which allows for speeding up the detection time and power delivery.

In a possible implementation form the wireless power transmitter apparatus is configured to transmit the f_{QPS} in one direction of the Dₘ or D_{m, k} at a time. The wireless power receiver device can be detected and the best direction to transmit the energy can be known even if the wireless power system is within a highly multipath environment or at non-line-of-sight conditions.

In a possible implementation form the wireless power transmitter apparatus is configured to record a direction associated with a detected f_{BS} based on the Dₘ of the corresponding transmitted f_{QPS}. The wireless power receiver device cooperates with the wireless power transmitter device in order to be detectable and to allow the wireless power transmitter device to find the best direction to transmit the RF energy.

In a possible implementation form the f_{BS} transmitted by the wireless power receiver apparatus is a signal modulated by an fₙ of the f_{QPS}. The frequency of oscillation is related with the input RF power enabling the detection of targets, such as battery-less wireless power receiver apparatus, or wireless power receiver apparatus that cannot initiate signaling to request wireless power.

In a possible implementation form the wireless power transmitter apparatus is configured to determine from the fₙ that the pre-determined amount of RF power is being delivered to the wireless power receiver apparatus. The frequency of oscillation is related with the input RF power enabling the detection of targets, such as battery-less wireless power receiver apparatus, or wireless power receiver apparatus that cannot initiate signaling to request wireless power.

In a possible implementation form the wireless power transmitter apparatus includes a backscatter apparatus configured to transmit an f_{BC} when the wireless power transmitter apparatus transmits the f_{QPS} and to detect the f_{BS} transmitted by the wireless power receiver apparatus. The f_{BC} is transmitted whenever the wireless power transmitter apparatus wants to listen to a wireless power receiver apparatus.

In a possible implementation form the f_{BC} can be transmitted simultaneously with the fₙ. The f_{BC} is transmitted whenever the wireless power transmitter apparatus wants to listen to a wireless power receiver apparatus.

In a possible implementation form the wireless power receiver apparatus is configured to transmit the f_{BS} when an RF power of the f_{QPS} received by the wireless power receiver apparatus exceeds a pre-determined power threshold. The f_{BS} is generated when the wireless power receiver apparatus is receiving a certain amount of RF power, which can be less than the RF power required to operate the receiver.

In a possible implementation form the wireless power receiver apparatus has a plurality of query power signal receiver paths, where individual ones of the plurality of query power signal receiver paths are associated with a different pre-determined power threshold. The wireless power receiver apparatus is configured to transmit the f_{BS} when a received power associated with the f_{QPS} exceeds a pre-determined power threshold of one of the plurality of query power signal receiver paths. The aspects of the disclosed embodiments provide a single path for each f_{QPS} and each path has its own power threshold.

In a possible implementation form the wireless power transmitter apparatus is further configured, when the pre-determined received amount of power is less than the required amount of power to transmit a next query power signal (f_{QPSn+1}), the f_{QPSn+1} associated with a received RF power that is higher than an RF power of the f_{QPS}. The aspects of the disclosed embodiments can iteratively query for a higher amount of RF power delivered until the power delivery requirements of the wireless power receiver are met.

In a possible implementation form the wireless power transmitter apparatus is further configured to determine the Dₘ associated with the f_{BS} and transmit the f_{QPSn+1} in D_{k,m} associated with the Dₘ. The aspects of the disclosed embodiments enable a fast focus of the beam direction for wireless power delivery.

In a possible implementation form when the wireless power transmitter apparatus does not detect the f_{BS}, the wireless power transmitter apparatus is further configured to change a beam pattern (Pₖ) with a beam width (φₖ) and gain (gₖ) associated with the f_{QPS} to a next beam pattern (Pₖ₊₁) with a next beam width (φₖ₊₁) and next gain (gₖ₊₁), where the φₖ₊₁ of the Pₖ₊₁ is narrower than the φₖ of the Pₖ and the next gain (gₖ₊₁) is greater than the gₖ; and transmit the f_{QPS} with the φₖ₊₁ and gₖ₊₁. When the wireless power transmitter does not detect the f_{BS} this can trigger the use of the f_{QPS} with a new beam pattern of narrower width and higher gain. To overcome propagation path loss, the beam width is traded for antenna gain.

In a possible implementation form the wireless power transmitter apparatus is further configured to iteratively narrow the φₖ₊₁ of the Pₖ₊₁ until the f_{BS} detected by the wireless power transmitter apparatus indicates that the required amount of power is being delivered to the wireless power receiver apparatus. Narrowing the beam width will increase the antenna gain.

In a possible implementation form the wireless power receiver apparatus includes a switching apparatus (T₁) configured to modulate the f_{BC} to generate the f_{BS}. An input sensitivity of the T₁ is less than an input power threshold required to power on the wireless power receiver apparatus. The aspects of the disclosed embodiments enable the generation of the backscatter signal even when the wireless power receiver is not receiving enough RF power to be operational.

According to a second aspect, the above and further objectives and advantages are obtained by a wireless power transmitter apparatus. In one embodiment, the wireless power transmitter apparatus is configured to transmit an f_{QPS}; detect an f_{BS} sent from a wireless power receiver apparatus; determine from the detected f_{BS} if a wireless power delivery requirement of the wireless power receiver apparatus is met; and deliver wireless power to the wireless power receiver apparatus if the wireless power delivery requirement is met. The aspects of the disclosed embodiments enable the detection of targets, such as battery-less wireless power receiver apparatus, or wireless power receiver apparatus that cannot initiate signaling to request wireless power.

In a possible implementation form, the wireless power transmitter apparatus is configured to transmit an f_{BC} when the f_{QPS} is being transmitted. The wireless power transmitter apparatus can transmit the f_{BC} when it wants to listen to a wireless power receiver apparatus.

According to a third aspect, the above and further objectives and advantages are obtained by a wireless power receiver apparatus. In one embodiment, the wireless power receiver apparatus is configured to receive an f_{QPS} and transmit an f_{BS} when an RF power of the f_{QPS} received by the wireless power receiver apparatus exceeds a pre-determined power threshold. The aspects of the disclosed embodiments enable the detection of targets, such as battery-less wireless power receiver apparatus, or wireless power receiver apparatus that cannot initiate signaling to request wireless power.

In a possible implementation form the wireless power receiver apparatus forms the f_{BS} by modulating a received f_{BC} with an fₙ of the f_{QPS}. The frequency of oscillation is related with the input RF power enabling the detection of targets, such as battery-less wireless power receiver apparatus, or wireless power receiver apparatus that cannot initiate signaling to request wireless power.

According to a fourth aspect, the above and further objectives and advantages are obtained by a method. In one embodiment the method includes transmitting an f_{QPS} from a wireless power transmitter apparatus, detecting an f_{BS} sent from a wireless power receiver apparatus in an energy depleted state responsive to the f_{QPS}, determining from the f_{BS} if a wireless power delivery requirement of the wireless power receiver is met, and delivering wireless power to the wireless power receiver apparatus when the wireless power delivery requirement is met. The aspects of the disclosed embodiments enable the detection of targets, such as battery-less wireless power receiver apparatus, or wireless power receiver apparatus that cannot initiate signaling to request wireless power.

In a possible implementation form, when the f_{BS} is not detected, the method further comprises changing a Pₖ associated with the f_{QPS} to a Pₖ₊₁, wherein an φₖ₊₁ of the Pₖ₊₁ is narrower than an φₖ of the Pₖ and a gₖ₊₁ is greater than a gₖ, and transmitting the f_{QPS} with the Pₖ₊₁. The aspects of the disclosed embodiments enable fast detection and delivery of wireless power to a wireless power receiver device by focusing the RF energy from a high gain beam-forming/beam-shaping antenna towards the battery-less wireless power receiver device or wireless power receiver device with a depleted battery.

In a possible implementation form, when the pre-determined amount of delivered power is less than the required amount of power, the method further includes transmitting an f_{QPSn+1}, the f_{QPSn+1} associated with a received RF power that is higher than an RF power of the f_{QPS}. The aspects of the disclosed embodiments enable fast detection and delivery of wireless power to a wireless power receiver device by focusing the RF energy from a high gain beam-forming/beam-shaping antenna towards the battery-less wireless power receiver device or wireless power receiver device with a depleted battery.

In a possible implementation form the wireless power transmitter apparatus is a high-gain beam shaping antenna. The aspects of the disclosed embodiments enable fast detection and delivery of wireless power to a wireless power receiver device by focusing the RF energy from a high gain beam-forming/beam-shaping antenna towards the battery-less wireless power receiver device or wireless power receiver device with a depleted battery.

In a possible implementation form the wireless power receiver apparatus is in an energy depleted state. The aspects of the disclosed embodiments enable fast detection and delivery of wireless power to a wireless power receiver device by focusing the RF energy from a high gain beam-forming/beam-shaping antenna towards the battery-less wireless power receiver device or wireless power receiver device with a depleted battery.

According to a fifth aspect, the above and further objectives and advantages are obtained by a non-transitory computer readable medium having stored thereon program instructions. The program instructions, when executed by a processor, are configured to cause the processor to perform the method according to any one or more of the possible implementation forms described herein.

These and other aspects, implementation forms, and advantages of the exemplary embodiments will become apparent from the embodiments described herein considered in conjunction with the accompanying drawings. It is to be understood, however, that the description and drawings are designed solely for purposes of illustration and not as a definition of the limits of the disclosure, for which reference should be made to the appended claims. Additional aspects and advantages of the disclosure will be set forth in the description that follows, and in part will be obvious from the description, or may be learned by practice of the disclosure. Moreover, the aspects and advantages of the disclosure may be realized and obtained by means of the instrumentalities and combinations particularly pointed out in the appended claims.

### BRIEF DESCRIPTION OF DRAWINGS

The following portion of the disclosure is explained in more detail with reference to the example embodiments shown in the drawings, in which:

FIG. 1 illustrates a block diagram of an exemplary wireless power transfer system incorporating aspects of the disclosed embodiments.

FIG. 2 illustrates a schematic block diagram of an exemplary wireless power transfer system incorporating aspects of the disclosed embodiments.

FIG. 3 illustrates a schematic block diagram of an exemplary wireless power transmitter apparatus for a wireless power transfer system incorporating aspects of the disclosed embodiments.

FIG. 4 illustrates a schematic block diagram of an exemplary wireless power receiver apparatus for a wireless power transfer system incorporating aspects of the disclosed embodiments.

FIG. 5 is a schematic diagram illustrating exemplary receiver power signal path thresholds in an exemplary wireless power receiver apparatus for a wireless power transfer system incorporating aspects of the disclosed embodiments.

FIG. 6 is a graph illustrating the relationship between output voltage and received RF power for an RF-DC converter in a wireless power receiver apparatus incorporating aspects of the disclosed embodiments.

FIG. 7 is a diagram illustrating exemplary FOV segmentation in a wireless power transfer system incorporating aspects of the disclosed embodiments.

FIGS. 8A-8C illustrates an exemplary process for beam focusing in a wireless power transfer system incorporating aspects of the disclosed embodiments.

FIG. 9 illustrates an exemplary process flow in a wireless power transfer system incorporating aspects of the disclosed embodiments.

### DESCRIPTION OF EMBODIMENTS

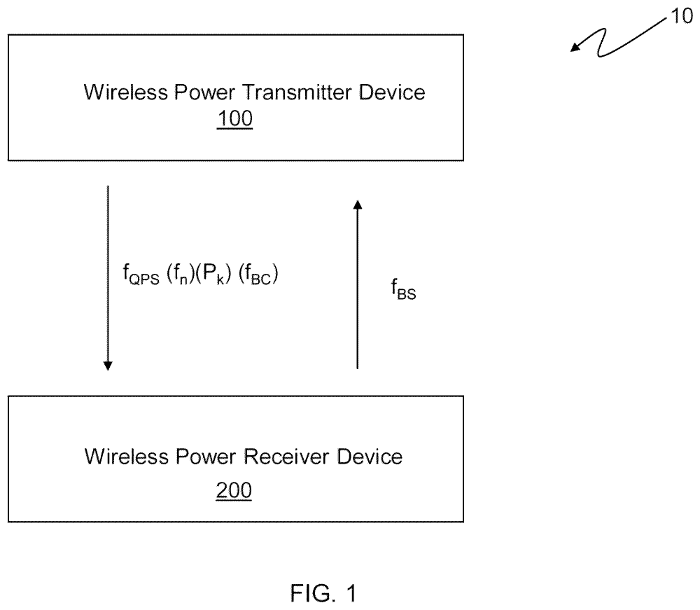

Referring to FIG. 1, a schematic block diagram of an exemplary WPTN or system 10 incorporating aspects of the disclosed embodiments is illustrated. The wireless power transfer system 10 of the disclosed embodiments is configured to provide wireless power transfer services. The wireless power transfer services can include, but are not limited to, far-field wireless charging. The aspects of the disclosed embodiments are directed to fast detection and fast focus of the energy emitted by high gain wireless power antenna systems of a wireless power transmitter apparatus 100 to a wireless power receiver apparatus 200 that cannot initiate a signaling request. Such wireless power receiver apparatus 200 include, but are not limited to, battery-less apparatus, apparatus with a depleted battery that is to be re-charged and apparatus that are otherwise in an energy depleted state.

As shown in FIG. 1, the wireless power transfer system 10 comprises a wireless power transmitter apparatus 100 and a wireless power receiver apparatus 200. Although only one wireless power transmitter apparatus 100 and one wireless power receiver apparatus 200 are shown in FIG. 1, the aspects of the disclosed embodiments are not so limited. In alternate embodiments, the wireless power transfer system 10 can include any suitable number of wireless power transmitter apparatus 100 and wireless power receiver apparatus 200, other than including one.

As illustrated in FIG. 1, the wireless power transmitter apparatus 100 is configured to transmit an f_{QPS}. The wireless power receiver apparatus 200 is configured to detect the f_{QPS} and transmit an f_{BS} in reply. The f_{QPS} is generally configured to “ask” the wireless power receiver apparatus 200 if it is collecting, at least, a certain predefined amount of power.

In this example, the wireless power receiver apparatus 200 is in an energy depleted state, generally meaning that the wireless power receiver apparatus 200 does not have enough stored energy to initiate communication with the wireless power transmitter apparatus 100. If the wireless power receiver apparatus 200 can “answer” with the f_{BS}, that generally indicates that the wireless power receiver apparatus 200 is receiving at least a certain amount of RF power. This certain amount of RF power may be less than the power used to operate the wireless power receiver apparatus 200.

In one embodiment, the wireless power transmitter apparatus 100 is configured to detect the f_{BS} from the wireless power receiver apparatus 200, determine from the detected f_{BS} if a wireless power delivery requirement of the wireless power receiver apparatus 200 is met, and deliver wireless power to the wireless power receiver apparatus 200 if the wireless power delivery requirement is met.

In a typical wireless power transfer system, the use of high gain antennas to deliver wireless power generally uses some kind of localization and/or feedback technique in order to focus the narrow beam toward the wireless power receiver and minimize the transmission losses by choosing the best transmission technique. However, these techniques generally include the receiver apparatus being powered on to initiate communication and detection.

Where backscatter signaling is used, such backscatter signaling generates a clock and/or data modulation signal within the wireless power receiver. This signal is usually generated with a processing unit, such as a microcontroller or a voltage controlled oscillator (VCO). The use of a processing unit to generate the modulation signal uses a certain amount of power and can introduce additional delay to the scanning/detection of battery-less power receivers due to the initialization of protocols, overheads and possible signal sampling.

The aspects of the disclosed embodiments enable the detection of targets, such as battery-less wireless power receiver apparatus, or wireless power receiver apparatus that cannot initiate signaling to request wireless power. The wireless power receiver apparatus 200 of the disclosed embodiments can be detected and the best direction to transmit the RF energy can be determined even if the wireless power receiver apparatus 200 is within a highly multipath environment or non-line-of-sight conditions. The wireless power receiver apparatus cooperates 200 with the wireless power transmitter apparatus 100 in order to be detectable and to allow the wireless power transmitter apparatus 100 to find the best direction to transmit the energy.

In the example of FIG. 1, the wireless f_{QPS} transmitted by the wireless power transmitter apparatus 100, also referred to herein are used to detect and to query a wireless power receiver 200 about its received wireless power signal strength. Based on the response of the wireless power receiver apparatus 200 to the f_{QPS} through backscatter signaling, the wireless power transmitter apparatus 100 may iteratively adjust its Pₖ until it delivers the required amount of power.

Each f_{QPS} is generally configured to “ask” the wireless power receiver apparatus 200 if it is collecting, at least, a certain predefined amount of power. The wireless power receiver apparatus 200 is configured to answer the f_{QPS} from the wireless power transmitter apparatus 100 through backscatter signaling. The aspects of the disclosed embodiments use backscatter signaling but without generating a backscatter modulation signal within the wireless power receiver apparatus 200, thus providing a low cost and simple solution.

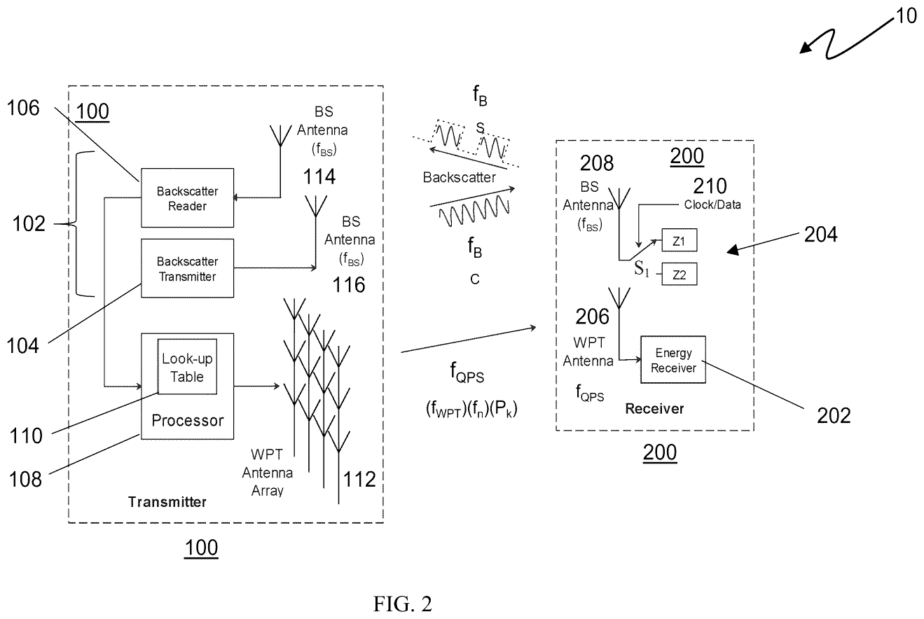

FIG. 2 illustrates a schematic block diagram of one example of a backscatter communication link between a wireless power transmitter apparatus 100 and a wireless power receiver apparatus 200 in a WPTN 10 incorporating aspects of the disclosed embodiments. As illustrated in the example of FIG. 2, the wireless power transmitter 100 is equipped with a backscatter module 102. In the example of FIG. 2, the backscatter module 102 includes a backscatter transmitter 104 and a backscatter reader 106. The backscatter transmitter 104 is coupled to an antenna 114 and the backscatter reader 106 is coupled to an antenna 116.

The backscatter transmitter 104 is configured to transmit an f_{BC}. The f_{BC} is used whenever the wireless power transmitter apparatus 100 wants to “listen” for a wireless power receiver apparatus 200.

The backscatter reader 106 is generally configured to listen for the feedback provided by the wireless power receiver apparatus 200. As described herein, the feedback is generally in the form of the f_{BS}. In one embodiment, the f_{BS} generally comprises the f_{BC}, modulated by an fₙ of the f_{QPS}.

The wireless power transfer system 10 of the disclosed embodiments is configured to operate with two different frequencies. As used herein, f_{WPT} refers to the carrier frequency used for wireless power transfer. The frequency f_{BC} refers to the carrier frequency transmitted by the backscatter transmitter 104 and used for feedback through backscatter signaling. The aspects of the disclosed embodiments generally use distinct carrier frequencies for successful operation.

In one embodiment, the backscatter module 102 is configured to continuously transmit a CW f_{BC} through the backscatter module transmitter 104. The f_{BS} is generally configured to “illuminate” the whole FOV of the wireless power transmitter apparatus 100. Typically, low gain antennas are employed to transmit the f_{BC}.

In one embodiment, the wireless power receiver apparatus 200 shown in FIG. 2 includes an energy receiving block 202 and a backscatter modulator 204. The energy receiving block 202 is responsible to convert the wireless energy collected by the receiving antenna 206 of the wireless power receiver 200 into usable direct current (DC) energy, which will be used to power up the wireless power receiver apparatus 200.

In the example of FIG. 2, the backscatter module 204 of the wireless power receiver apparatus 200 includes a receive/transmit antenna 208 and a switch S₁. As further described herein, S₁ is generally configured to switch the antenna 208 between two termination loads shown as Z1 and Z2.

S₁ is configured by a data/clock modulation signal 210. The load terminations Z1 and Z2 may be a matched load and a pure reactive load for amplitude-shift keying (ASK) modulation, or pure reactive loads with 180 degrees of phase shift for binary phase-shift keying (BPSK) modulation. The aspects of the disclosed embodiments can include other modulations, which can be generated by adding additional termination loads, such as for example M-ary phase-shift keying (M-PSK) and quadrature phase-shift keying (QPSK).

S₁ can be any suitable type of switching apparatus. Examples include, but are not limited to, a transistor or a diode. The backscatter module 204 is configured to modulate and transmit the f_{BC} back to the wireless power transmitter apparatus 100 based on predefined conditions.

The clock and/or data modulation signal 210 shown in FIG. 2 is configured to modulate the f_{BC} and enable the module 204 to send the f_{BS} back to the wireless power transmitter 100. As described herein, the signal 210 is generated only when the wireless power receiver 200 has enough energy to operate. Although the backscatter module 204 of the wireless power receiver apparatus 200 relies on the clock/data modulation signal 210, the wireless power receiver apparatus 200 does not require a processing unit to generate such signal 210. The use of a processing unit would be a critical source of power consumption and delay due to the initialization overheads that would occur after turn-on of such a processing unit. The lack of a processing unit, analog-to-digital converter (ADC) sampling or the generation of such signal within the wireless power receiver 200 itself, allows the wireless power receiver 200 to be fast, simple and low cost.

The backscatter reader 106 of the backscatter apparatus 102 shown in FIG. 2 is configured to detect the f_{BS} sent by the wireless power receiver apparatus 200. As described further herein, the detection of the f_{BS} or absence of detection of the f_{BS} will trigger an action in the wireless power transmitter apparatus 100.

Although a bi-static backscatter configuration is shown in the example of FIG. 2, the aspects of the disclosed embodiments are not so limited. In alternate embodiments, any suitable backscatter configuration can be considered, such as a mono-static configuration. Mono-static configuration uses a single antenna for transmit and receive. A circulator may be used to separate the transmitter from the receiver in this implementation.

As described further herein, the aspects of the disclosed embodiments rely on beam-forming/beam-shaping antennas and backscatter communications in a wireless power transfer system 10 that can detect and focus wireless power towards a wireless power receiver apparatus 200 in an energy depleted state. These wireless power receiver apparatus 200 are generally disposed or otherwise positioned within the range of high gain wireless power transmitting antenna systems 112 of the wireless power transmitter apparatus 100.

In one embodiment, the wireless power transmitter apparatus 100 is a high gain antenna array 112 with beam-forming and/or beam-shaping capabilities. The wireless power transmitter apparatus 100 may produce Pₓ for the f_{QPS} with different φₖ and gₖ, as well as transmit the f_{QPS} in several directions. The wireless power transmitter apparatus 100 is configured to trade its maximum gain for a larger beam-width.

In one embodiment, the wireless power transmitter apparatus 100 can include a processor(s) or processing unit 108. The processing unit 108 can be a microcontroller, digital signal processor (DSP) or field-programmable gate array (FPGA), for example. The processing unit or processor 108 is configured to provide the control signals for setting the phase and/or amplitude of the f_{QPS} that is fed to each element of the antenna 112 of the wireless power transmitter apparatus 100. One or more of the phase and amplitude of the f_{QPS} described herein can be adjusted to a form an φₖ with a specific beam-width and with a maximum RF power intensity towards specific Dₘ or D_{m,k}. This is also known as beam-forming or beam-shaping.

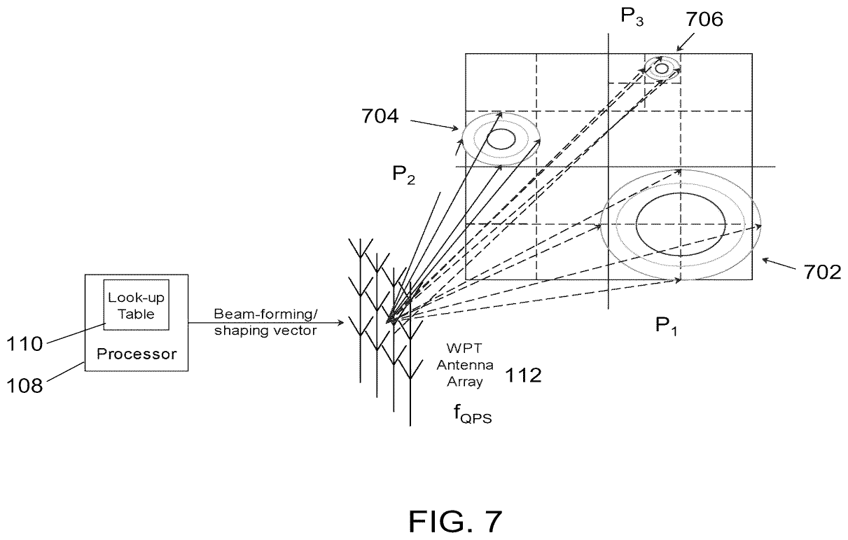

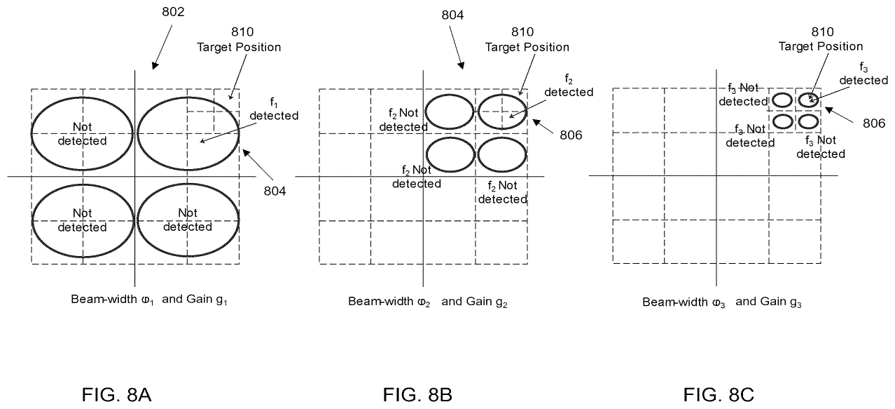

When the Pₖ is shaped, the maximum gain can decrease. In one embodiment, a look-up table of phases and/or amplitudes is stored within a memory 110 or other suitable storage medium of the processing unit 108. This look-up table can be accessed to identify the control signals that are applied to generate certain Pₖ. For example, in one embodiment, the look-up table should contain the control signals that are used to generate the Pₖ that cover several segments of the total FOV of the wireless power transmitter 100 as is described herein. Examples of such Pₖ with different φₖ are shown in FIGS. 7 and 8.

In one embodiment, the wireless power transmitter 100 will include or be communicatively connected to the memory or storage apparatus 110. The memory 110 is generally configured to store or maintain information or data related to the wireless power transmitter apparatus 100 and the wireless power receiver apparatus 200. In addition to the phase, amplitude and control signals described above, the information stored in the memory 110 could also include, but is not limited to, a capability of each wireless power transmitter apparatus 100, a number and type of antennas, a number of supported beam directions, per unit power delivery capabilities, a type of the wireless power receiver apparatus 200, a type of battery, remaining charging time, priority and receiver identifier.

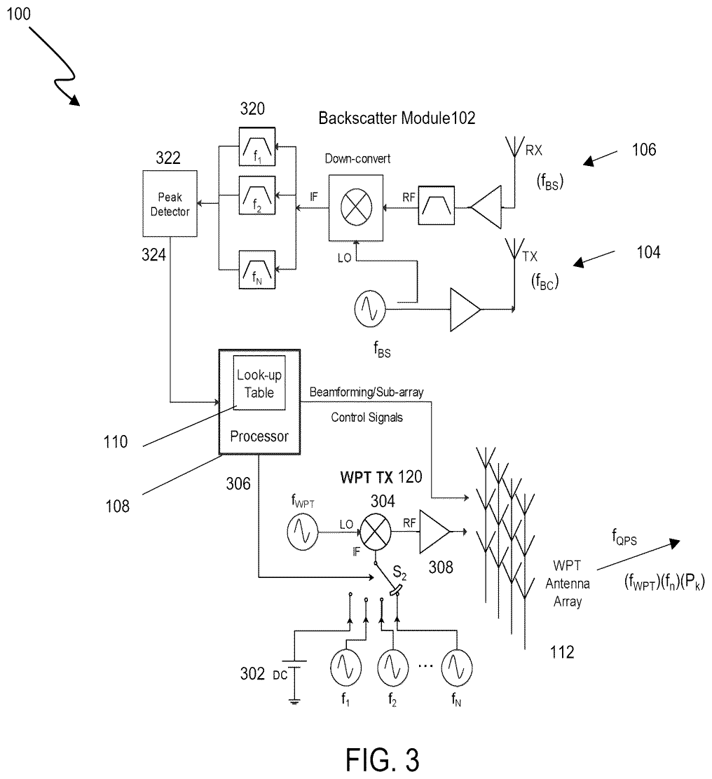

FIG. 3 illustrates a schematic block diagram of the wireless power transmitter apparatus 100. In this example the wireless power transmitter apparatus 100 includes the backscatter module 102 and the wireless power transmitter 120. The backscatter module 102, which in this example includes the backscatter transmitter 104 and the backscatter reader 106 of the backscatter module 102 may or may not be co-located with the wireless power transmitter 120. The wireless power transmitter 120 of the wireless power transmitter apparatus 100 is generally configured to switch between CW operation and pulsed operation at f₁, f₂, . . . f_{N}, where N is the total number of pulsed signals.

Referring to the example of FIG. 3, CW operation is set by mixing the f_{WPT} (typically in the gigahertz (GHz) range) generated by a power source with a DC component 302. CW operation will be used when the best direction to transmit the RF energy to the wireless power receiver 200 is found, as is further described herein.

In pulsed operation, the f_{WPT} is mixed, via mixer 304, with a low frequency oscillator such as one of f₁, f₂, . . . f_{N}. In one embodiment, the low frequency oscillator f₁, f₂, . . . f_{N} is in the megahertz (MHz) range. A single VCO may be used to generate the low frequency signals f₁, f₂, . . . f_{N}, also referred to herein as “query modulation signal component fₙ” for descriptive purposes only.

This mixing will produce an ON/OFF wireless f_{QPS}, with fₙ, which will be used to detect and to query the wireless power receiver apparatus 200. Based on the response, or lack of response by the wireless power receiver apparatus 200 to the f_{QPS}, the wireless power transmitter apparatus 100 shall be guided until it delivers the required power to the wireless power receiver apparatus 200. As used herein, the term “required power” generally refers to an amount of received RF power that is needed for the wireless power receiver apparatus 200 to operate.

The fₙ of the f_{QPS} is generally configured to “ask” the wireless power receiver 200 if it is collecting, at least, a certain predefined amount of power. The amount of RF power associated with the fₙ is known by the wireless power transmitter apparatus 100. For example, in one embodiment, the amount of RF power associated with a specific fₙ is stored in the memory 110.

In one embodiment, instead of an up-conversion architecture, a switch S₂, or other similar apparatus may be used to switch ON/OFF the f_{WPT} generated by the VCO at the frequencies f₁, f₂, . . . f_{N}, effectively creating pulse modulation. In one embodiment, an additional pulse shaping block may be added to smooth out the pulsed waveform and to decrease the out-of-band spectrum emission.

In one embodiment, the processing unit 108 of the wireless power transmitter apparatus 100 is configured to control the CW operation, pulsed operation and the pulse period by sending a control signal 306 to the switch S₂. As further described herein, the processing unit 108 can also be configured to control which φₖ should be used at any given time instant. The CW or pulsed power signal, generally referred to herein as “query power signal f_{QPS}” can then be amplified via an amplifier 308 to a transmission power level and delivered to the transmitting antenna array 112 of the wireless power transmitter apparatus 100.

The pulsed wireless f_{QPSn} transmitted by the wireless power transmitter apparatus 100 as shown in FIG. 3 are used to detect and query a wireless power receiver apparatus 200 about its received wireless power signal strength. Based on the response of the wireless power receiver apparatus 200 to the f_{QPSn}, through backscatter signaling, as described further herein, the wireless power transmitter apparatus 100 is configured to iteratively adjust the Pₖ of the f_{QPSn} until the required amount of power is delivered. The wireless power transmitter apparatus 100 is configured to switch to the CW mode of operation once it is determined that the required amount of power is being delivered.

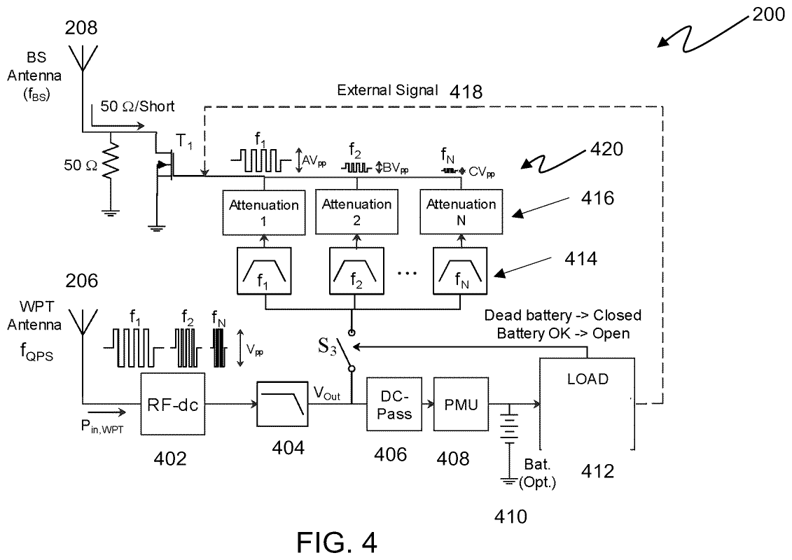

FIG. 4 illustrates one example of a wireless power receiver apparatus 200 incorporating aspects of the disclosed embodiments. The wireless power receiver apparatus 200 is generally configured to answer to the f_{QPS} sent from the wireless power transmitter apparatus 100 through backscatter signaling.

As is shown in this example, an RF-DC converter 402 is configured to convert the collected RF energy of the f_{QPS} at f_{WPT} to usable DC energy. A low-pass filter 404 is added to the output of the RF-DC converter 402 to filter out the fundamental frequency f_{WPT} of the f_{QPS} and the harmonics generated by the rectifying process. The low-pass filter 404 is configured to allow DC and the low frequency modulations f₁, f₂ . . . f_{N} of the f_{QPS} to pass through, where f_{N}<<1/RC<<f_{WPT}.

As shown in the example of FIG. 4, the DC power produced by the RF-DC converter 402 is routed through a DC-pass filter 406 (or RF choke) to the Power Management Unit (PMU) 408. In one embodiment, the PMU 408 is configured to charge a battery 410, if any. The PMU 408 can also be used to power a load 412. The load 412, can include, but is not limited to, a processing unit or processor, sensor, actuator, dedicated communication module such as WI-FI™, BLUETOOTH™, ZIGBEE™, or any other electronic apparatus or component of the wireless power receiver apparatus 200.

In one embodiment, the wireless power receiver apparatus 200 also comprises a switch S₃. One side of S₃ is coupled or otherwise connected to the output of the RF-DC converter 402. The other side of S₃ is coupled or otherwise connected to a bank of filters 414.

As illustrated in the example of FIG. 4, S₃ is configured to be open when the wireless power receiver apparatus 200 has enough stored energy to guarantee normal operation. If S₃ is open, the wireless power receiver apparatus 200 will not provide any answer to the f_{QPS} as described herein.

In one embodiment, the S₃ can be configured to be in the closed and connected state when the wireless power receiver apparatus 200 is in the energy depleted state. When S₃ is closed the low frequency components (<1/RC) produced by the RF-DC converter 402 are communicated to the bank of filters 414.

When in the energy depleted state, the wireless power receiver apparatus 200 has no energy to initiate a request for wireless charging. In one embodiment, S₃ can be a relay with a “closed” default state. S₃ can be set to “open” by an external control signal provided by a microcontroller or directly from the battery 410, if any.

As illustrated in the example of FIG. 4, when S₃ is in the closed state, the low frequency modulations f₁, f₂ . . . f_{N} of the f_{QPS}, or fₙ, will be routed to a bank of filters 414, also referred to as filter bank 414. The filter bank 414 generally includes a plurality of filters. In one embodiment, the filters in the filter bank 414 are band-pass filters. As such, no DC power will flow through the band-pass filters.

The filters in the filter bank 414 are matched to the frequency of the low frequency oscillators f₁, f₂ . . . f_{N} of the wireless power transmitter apparatus of FIG. 3. Thus, for each fₙ, there will be a corresponding filter in the filter bank 414.

In one embodiment, the wireless power receiver apparatus 200 does not include S₃. In this example, a straight connection is provided between the output Vₒᵤₜ of the RF-DC converter 402 and the filter bank 414. When there is such a direct connection, the wireless power receiver apparatus 200 may provide a response to the f_{QPS} from the wireless power transmitter apparatus 100 through the backscatter link even if when the wireless power receiver apparatus 200 does not use wireless power.

The wireless power transmitter apparatus 100 of FIG. 3 is generally configured to transmit one f_{QPS}, with fₙ, at a time. For example, if the f_{QPS} with f₁ is received by the wireless power receiver apparatus 200 shown in FIG. 4, the f₁ will be routed through the band-pass filter of the filter bank 414 with that same pass-frequency or the corresponding low frequency oscillator signal f₁.

As shown in the example of FIG. 4, the wireless power receiver apparatus 200 also includes an attenuation block 416 that is connected to the output of the filter bank 414. The attenuation block 416 includes a plurality of blocks labelled as Attenuation 1 to Attenuation N. The individual filters of the filter bank 414 are connected to respective blocks of the attenuation block 416. The combination of S₃, filter bank 414 and attenuation block 416 generally comprises the query power signal receiver path or paths 420. For each f_{QPSn}, and fₙ, there will be a respective query power signal receiver path 420.

In one embodiment, the attenuation of different ones of the blocks in the attenuation block 416 can vary. For example, an attenuation value of Attenuation 1 can be less than the attenuation value of Attenuation 2, which is less than the attenuation value of Attention N. In alternate embodiments, the blocks of the attenuation block 416 can have any suitable values.

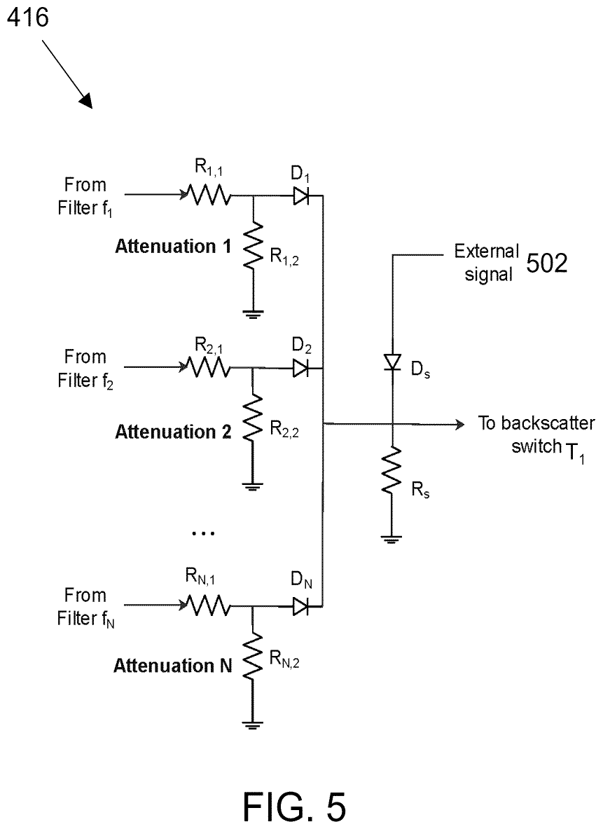

FIG. 5 illustrates one example of an attenuation block 416. In this example, the attenuation block 416 includes a plurality of resistive voltage dividers, such as R_{N,1}, R_{N,2} followed by an isolation diode D_{N}. D_{N} is used to ensure isolation between the resistive voltage dividers of the filter block 416.

Referring again to FIG. 4, in one embodiment, the wireless power receiver apparatus 200 includes a switch T₁. T₁ will also be referred to herein as the “backscatter” switch T₁, and is similar in form and function to S₁ described with respect to FIG. 2. As is shown in the examples of FIGS. 4 and 5, the output of the attenuation block 416 is connected to T₁.

T₁ is generally configured to switch between OFF and ON or ON and OFF based on a control input. In one embodiment, T₁ is a transistor. In alternate embodiments, T₁ can be any suitable switching apparatus.

As described further herein, when S₃ is in the closed state, the aspects of the disclosed embodiments provide for the fₙ component of the f_{QPS} to turn T₁ ON and OFF. This switching will add ON/OFF modulation to the f_{BC} that is received from the wireless power transmitter apparatus 100 at a frequency that is equal to the frequency of fₙ, or the respective low frequency oscillator signal f₁, f₂ . . . f_{N}, portion of the f_{QPS}.

To activate the switching of T₁, the peak-to-peak voltage of the fₙ portion of the f_{QPS} must be large enough, after attenuation by the corresponding block in attenuation block 416, to surpass the threshold of T₁. When the peak-to-peak voltage of fₙ is large enough, the fₙ will effectively switch ON/OFF T₁, modulating the received f_{BC} at one of the low frequency oscillators f₁ to f_{N}.

In the example of FIG. 4, T₁ is configured to alternately connect the backscatter antenna 208 between a 50 Ohm load and a short circuit. This adds an ON/OFF modulation to the f_{BC} at a frequency that is equal to the frequency of fₙ. This modulation is similar to what is described with respect to signal 210 herein.

The generated f_{BS} will be the f_{BC} modulated by fₙ. This modulated signal, also referred to as the backscatter signal f_{BS}, is then sent back to the wireless power transmitter apparatus 100, where it can be detected by the backscatter reader 104 of FIG. 2.

The time used by the feedback mechanism shown in FIG. 4 to generate f_{BS} responsive to the f_{QPS} should be mainly determined by the backscatter free-space propagation delay, allowing it to operate as close as possible to real-time. In one embodiment, crystal oscillators and crystal filters may be used for perfect frequency match. Crystal filters are particular suitable due to high selectivity, eliminating unwanted noise and/or external interferers.

Referring again to FIG. 3, in one embodiment, the received f_{BS} is down-converted and filtered by narrow-band band-pass filters 320. The narrow-band band pass filters are matched to the ON/OFF frequency of the low frequency oscillator signals f₁, f₂ . . . f_{N} of the wireless power transmitter apparatus 100.

In one embodiment, a peak detector 322 is used to detect the presence of the frequency components of the fₙ, the low frequency oscillator signals f₁, f₂ . . . f_{N}. The peak detector 322 can be configured to generate a “high” DC voltage if a frequency component corresponding to the frequency component of the low frequency oscillator signals f₁, f₂ . . . f_{N} is detected and a “low” DC voltage if no frequency component is detected. The output signal 324 from the peak detector 322 is then routed to the processing unit 108 to trigger an action, such as to set a new Pₖ or a generate a new f_{QPSn+1}.

The fₙ of the f_{QPS} can be understood as a question to the wireless power receiver apparatus 200 as to whether the wireless power receiver apparatus 200 is receiving, at least, a certain predefined amount of RF power. The detection of f_{BS} by the backscatter reader 104 of FIG. 2 means that the wireless power receiver apparatus 200 answered “yes” to the particular f_{QPSn} sent by the wireless power transmitter apparatus 100. If the modulated f_{BS} is not detected, this lack of a response will be understood or interpreted as a “no.”

There are N possible f_{QPS} with N modulations f₁, f₂ . . . f_{N} and N RF power thresholds. In the examples generally described herein, the received RF power associated with f_{PQS2} is greater than the received RF power associated with f_{PQS1}. Similarly, the received RF power associated with f_{PQSn+1} is greater that the received RF power associated with f_{QPSn}.

Also, the attenuation of attenuation block Attenuation 2 of FIG. 4 corresponding to signal f₂ is greater than the attenuation of attenuation block Attenuation 1 associated with signal f₁. The attenuation of attenuation block Attenuation N associated with f_{N} is greater than the attenuation of attenuation block Attenuation 2 associated with signal f₂. This means that the RF power, or the peak-to-peak voltage of the signal f₂, prior to attenuation, has to be greater than the RF power of the signal f₁ to switch T₁ ON/OFF, and the RF power of the signal f_{N}, prior to attenuation, has to be greater than the RF power of the signal f₂.

When the wireless power transmitter apparatus 100 is operated in CW mode, meaning it is transmitting wireless power to the wireless power receiver apparatus 200, there is no modulation frequency applied to T₁. The CW mode will only be set after the wireless power transmitter apparatus 100 is able to detect that the wireless power receiver apparatus 200 is receiving the required power to remain operational. During CW mode, the backscatter module 204 of the wireless power receiver apparatus 200 is free for other purposes, such as further signaling or information transfer. Using the backscatter module 204 of the wireless power receiver apparatus 200 for communications can reduce the energy consumption of the wireless power receiver apparatus 200. For example, instead of the wireless power receiver apparatus 200 using a typical power hungry dedicated communication module, such as WI-FI™, BLUETOOTH™ or ZIGBEE™, for communications, the wireless power receiver apparatus 200 may use the backscatter module 204.

In one embodiment, referring again to FIG. 5, during CW operation of the wireless power transmitter apparatus 100, an external information/control signal 502 may be generated within a processing unit of the wireless power receiver apparatus 200. In one embodiment, the processor or processing unit of the wireless power receiver apparatus 200 can comprise an ultra-low power microcontroller. In one embodiment, the signal 502 can be applied to T₁ through a diode D_{S}, as shown in FIG. 5, allowing the wireless power receiver apparatus 200 to communicate with the wireless power transmitter apparatus 100 through backscatter communications.

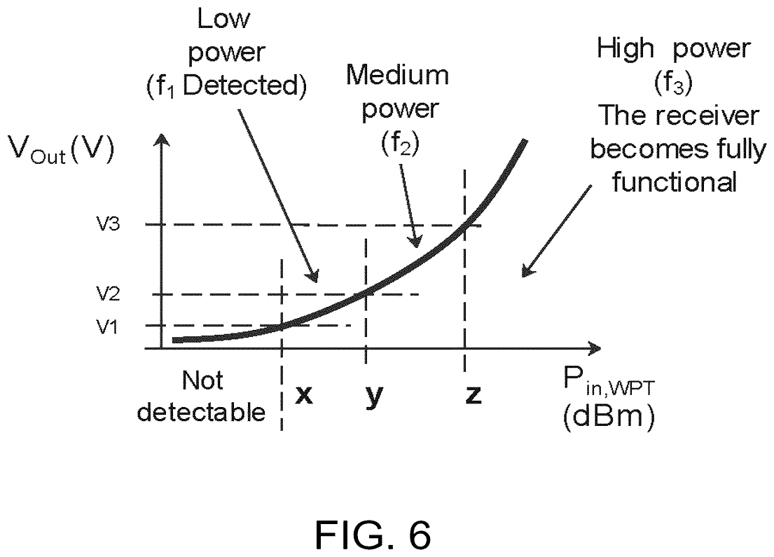

The voltage produced by an RF-DC converter depends on the input RF power. The higher the input RF power, the higher will be the voltage produced and the DC power. This behavior is represented in the graph of FIG. 6. Since T₁ has a fixed threshold, the individual attenuations of the attenuation block 416 corresponding to the signals f₁, f₂, . . . and f_{N}, is adjusted in order to switch T₁ ON/OFF at different input RF power levels.

In the example of FIG. 6, three signals, namely f₁, f₂ and f₃ are defined. The wireless power transmitter apparatus 100 may switch between CW operation and pulsed operation at f₁, f₂ or f₃. As is generally described herein, the pulsed signals f₁, f₂ and f₃ are used to query the wireless power receiver apparatus 200 about whether it is receiving at least x, y or z decibel-milliwatts (dBm) of RF power, respectively, from the f_{QPSn}.

Generally, the first pulsed signal, referred to herein as signal f₁, is used for detection purposes. If the signal f₁ is backscattered by the wireless power receiver 200 as described above, this indicates that the wireless power receiver apparatus 200 was detected and it is collecting at least x dBm of RF power. The signal f₁ is generally associated with or is configured to provide a minimum input RF power (x dBm) to surpass the voltage threshold level of T₁. The minimum input RF power that triggers such detection at f₁ is largely dependent on the type of RF-DC converter and its sensitivity. In one embodiment information about the signal f₁ and the power associated with signal f₁ can be stored in the memory 110 shown in FIG. 2.

Similarly, the next signal f₂ is configured to query the wireless power receiver apparatus 200 to determine whether it is receiving at least y dBm of RF power. The signal f₃ is configured to determine whether the wireless power receiver apparatus 200 is receiving at least z dBm. Generally, the RF power level of signal f₂ will be greater than the RF power level of signal f₁, and the RF power level of signal f₃ will be higher than the RF power level of signal f₂.

Referring again to FIG. 4, upon receiving an f_{QPSn} associated or modulated by f₁, f₂ or f₃, the RF-DC converter 402 will produce spectral components at DC and at f₁, f₂ or f₃. If the peak-to-peak voltage amplitude of the component produced at f₁, f₂ or f₃ is large enough, the voltage amplitude will surpass the corresponding attenuation of attenuation block 416 and the threshold of T₁, effectively switching it ON/OFF. The peak-to-peak voltage amplitude of the signal f₁, f₂ or f₃ is related to the input RF power.

Based on the received power of the signal f₁, f₂ or f₃, the wireless power receiver apparatus 200 will or will not reflect back, or otherwise send to the wireless power transmitter apparatus 100 the f_{BC} modulated by the respective frequency f₁, f₂ or f₃, referred to as f_{BS}. The transmission or absence of transmission of f_{BS} shall be understood as a “yes” or a “no” to the question “Are you receiving, at least, a certain predefined amount of RF power?” The input RF power level at which the backscatter signaling will occur at f₁, f₂ or f₃ can be defined by adjusting the value of their corresponding resistors at the attenuator block 416 shown in FIG. 5.

Every attenuation 1-N in the attenuation block 416 (or input RF power threshold) can be set independently. The input RF power required to backscatter a signal at f₁ and f₂ is much lower than the one required to keep the wireless power receiver apparatus 200 fully functional. The aspects of the disclosed embodiments can provide feedback to the wireless power transmitter apparatus 100 even if the received power is not enough to fully turn the wireless power receiver ON, including a processing unit and/or a dedicated communication module such as WI-FI™, BLUETOOTH™, or ZIGBEE™.

The aspects of the disclosed embodiments enable a fast focus of the required amount of energy towards a wireless power receiver apparatus 200 located within the FOV of the wireless power transmitter 100. Referring again to FIG. 1, the wireless power transmitter apparatus 100 is generally configured to use several combinations of Pₖ with different φₖ, gₖ, and f_{QPSn}. Although only beam patterns P₁, P₂ and P₃ are generally referred to herein, the aspects of the disclosed embodiments are not so limited. In alternate embodiments, any suitable number “k” of beam patterns “Pₖ” can be used.

To transmit wireless power to a wireless power receiver 200 located far away, Pₖ with the narrowest φₖ (highest gₖ and highest power delivered) are used. The aspects of the disclosed embodiments allow the wireless power transmitter apparatus 100 to select one of the 64 possible beam directions without trying them all, based on the feedback provided by the wireless power receiver apparatus 200 to the f_{QPSn}.

As shown in the example of FIG. 7, the aspects of the disclosed embodiments segment the total FOV of the antennas 112 of the wireless power transmitter 100. FIG. 2 illustrates the segmentation of the total FOV and power contours 702, 704, 706 produced by the beam patterns P₁, P₂ and P₃, respectively. In the example of FIG. 7, the φₖ of the individual beam patterns P₁, P₂ and P₃ are different. As shown in FIG. 7, the beam width φ₁ of beam pattern P₁ is greater than the beam width φ₂ of beam pattern P₂, which is greater than the beam width φ₃ of beam pattern P₃ (φ₁>φ₂>φ₃).

The gain g₁, g₂, g₃ associated with respective beam patterns P₁, P₂ and P₃ is also different. Generally, the larger the φₖ of the Pₖ, the lower the Gₖ, also described as the power that the wireless power transmitter apparatus 100 can deliver through a specific direction. In this example, g₁<g₂<g₃. The Pₖ with largest beam-width will have a broader coverage area, but less power delivered, generally per unit area. It is assumed that by using a larger beam pattern, the wireless power transmitter apparatus 100 can deliver at least x dBm of RF power to any wireless power receiver apparatus 200 located within its range.

In one embodiment, the largest beam pattern, such as beam pattern φ1 of FIG. 7, is configured to provide a minimum input RF power that is delivered to the wireless power receiver apparatus 200 to enable it to transmit to the wireless power transmitter apparatus 100, the f_{BS} modulated by the signal f₁. This particularity can be considered when designing the wireless power transfer system 10 and defining the RF link budget.

Referring to FIGS. 8A-8C, these example shows the use of three (3) beam patterns P₁, P₂ and P₃ for progressively smaller fields of view, illustrated as FOV 802, 804, 806. The FOVs 802, 804, 806 in the examples of FIGS. 8A-8C are divided into four quadrants. The beam width of the particular beam pattern P₁, P₂ and P₃ being used, is configured to generally cover or encompasses approximately one-quarter (¼) of the total FOV 802, 804, 806. FIGS. 8A-8C show a target position 810 of the exemplary wireless power receiver apparatus 200 in the respective FOV 802, 804, 806.

In this example, the beam patterns with the largest beam-width, namely φ₁, are configured to cover approximately ¼ of the total FOV, or use four beam directions to cover the entire FOV. The beam patterns P₂ are configured to cover approximately 1/16 of the total FOV. The beam patterns P₃ in this example are configured to cover approximately 1/64 of the total FOV. Thus, to cover the entire FOV, beam pattern P₁ uses four beam directions, beam pattern P₂ 16 beam directions, and beam pattern P₃ 64 beam directions. In alternate embodiments, any suitable technique to achieve different beam-width (covered area) and different gain (power delivered) may be used.

In one embodiment, the beam pattern P₁ can be used for initial detection purposes. The beam pattern P₁ in the example of FIG. 8A is designed with the largest beam width. In this example, the beam pattern P₁ is also used to transmit the query power signal f₁. The signal f₁ in this example is configured to provide a minimum input RF power that is delivered to the target wireless power receiver apparatus 200 to enable the target wireless power receiver apparatus 802 to transmit to the wireless power transmitter apparatus 100, the f_{BS} modulated by the modulation component of the query power signal f₁. In order to know which beam pattern P₁, P₂ and P₃ should be configured, the wireless power receiver 200 will provide feedback to the wireless power transmitter 100 through backscatter signaling.

In one embodiment, the beam patterns P₁, P₂ and P₃ can also be used for actual wireless power transfer if the target wireless power receiver apparatus 200 is close enough to the wireless power transmitter apparatus 100. In the example of FIG. 8A, using the beam pattern P₁, the wireless power transmitter apparatus 100 transmits signal f₁ in the four (4) possible directions. The four directions are selected to generally encompass the entire FOV 802 of the wireless power transmitter apparatus 100. If a wireless power receiver apparatus 200 is located within the total FOV 802 of the wireless power transmitter apparatus 100, there will be directions from which the backscatter carrier f_{BS} modulated by f₁ can be transmitted to the wireless power transmitter apparatus 100.

In one embodiment, a direction from which an f_{BS} is transmitted can be determined. For example, the signal f₁ is transmitted from the wireless power transmitter apparatus 100 in one direction at a time. If an f_{BC} modulated by signal f₁ is transmitted back and detected (also referred to herein as a “response” or backscatter signal f_{BS}), the direction associated with the particular transmission of signal f₁ can be identified. In alternate embodiments, any suitable manner of determining a direction from which an f_{BS} modulated by a particular signal f₁ is transmitted can be used.

In one embodiment, the direction(s) from which a response(s) is received is verified and stored in the memory 108. Then, while still using the beam pattern P₁ with the same beam width, the wireless power transmitter apparatus 100 switches to the signal f₂. The wireless power transmitter apparatus 100 is configured to transmit the signal f₂ using beam pattern P₁ in the direction from which the response to signal f₁ was received. If the target wireless power receiver apparatus 200 is within a predetermined range of the wireless power transmitter apparatus 100, the response to the signal f₂ may occur from specific direction that can be identified.

If a response to signal f₂ is received, f_{BC} modulated by f₂, the wireless power transmitter 100 is configured to switch to the signal f₃ while still using the beam pattern φ1. The wireless power transmitter 100 will transmit the query power signal f₃ in the direction from which the response to query signal f₂ was received, which is stored in the memory. If a response to the query signal f₃ occurs, it means that there is a direction from which the beam pattern P₁ can be used to deliver sufficient power to keep the wireless power receiver 200 operating in a fully functional manner. Thus, for the identified direction, the wireless power transmitter apparatus 100 can deliver z dBm of RF power using beam pattern P₁. The wireless power transmitter apparatus 100 can then switch to CW operation for wireless power delivery using the identified direction and beam pattern P₁.

In one embodiment, if the target wireless power receiver apparatus 200 is beyond a predetermined range, or too far away, from the wireless power transmitter apparatus 100, a narrower beam-width Pₖ to produce a higher gₖ may be used in order to find a direction to deliver the required amount of power.

Referring to FIG. 8C, the beam pattern P₃ represents the narrowest beam width of the patterns P₁ and P₂. As shown in FIG. 8C, the coverage area of the beam patterns P₃, represented by the circular regions, are much narrower as compared to the coverage of P₁ and P₂, due to the higher gain of P₃.

If one were to use the beam pattern P₃ in each of the sixteen quadrants represented in FIG. 8C, that would include trying sixty-four possible directions. Trying all sixty-four possible beam directions would not be practical and could be time consuming.

In one embodiment, after a response to signal f₁ using beam pattern P₁ is received, the wireless power transmitter apparatus 100 is configured to switch to signal f₂ with the same beam pattern P₁. The wireless power transmitter apparatus 100 is configured to scan the direction(s) from which it had a response to the signal f₁, using signal f₂ and beam pattern P₁.

In a situation where the wireless power receiver 200 is far away, or beyond a pre-determined range, there will be no f_{BS} to the query signal f₂ while using beam pattern P₁. In this case, the wireless power transmitter apparatus 100 will switch to beam pattern P₂, which has a narrower beam width than beam pattern P₁, Thus, beam pattern P₂ will provide a higher gain and can deliver additional RF power.

Referring to FIG. 8B, in one embodiment, the wireless power transmitter apparatus 100 is using beam pattern P₂, with query signal f₂. The wireless power transmitter apparatus 100 will scan the direction(s) from which it had a response to the query signal f₁ when using beam pattern P₁. Since the beam pattern P₂ has additional gain, the four (4) sub-directions shown in FIG. 8B, each covering 1/16 of the total FOV 804, are scanned.

After a response to the query signal f₂ is detected, the wireless power transmitter apparatus 100 is configured to switch to the query power signal f₃ still using the beam pattern P₂. The wireless power transmitter apparatus 100 is configured to scan the sub-directions 806 from which, in this example, it had a response to the signal f₂, now using signal f₃ and beam pattern P₂.

If a response is received from the target wireless power receiver apparatus 200 to the query signal f₃ and beam pattern P₂ this indicates that the wireless power receiver apparatus 200 is located at or within a range that the beam pattern P₂ can deliver z dBm of RF power to the target wireless power receiver apparatus 200.

However, if there is no response to the signal f₃ from the target wireless power receiver 200, the wireless power transmitter apparatus 100 is configured to switch to beam pattern P₃, which, in this example, is narrower than beam pattern P₂. The narrower beam pattern P₃ is configured to provide additional gain.

In the example of FIG. 8C, the wireless power transmitter apparatus 100 switches to the beam pattern P₃ and scans the sub-direction 806. This procedure can be repeated until the wireless power transmitter apparatus 100 finds a direction from which a response to the signal f₃ occurs.

When an f_{BS} is received that is modulated by f₃, this indicates that the identified direction will enable the wireless power receiver apparatus 200 to collect the required RF power for its proper operation. Once this direction is determined, the wireless power transmitter apparatus 100 can switch to CW operation for full charging mode (100% duty-cycle) and switch S₃ of FIG. 4 can be set to “open.” In one embodiment, the incremental gain between beam patterns P₁, P₂ and P₃ is designed to match the incremental input RF power that is needed to successively switch ON/OFF T₁ at f₁, f₂ and f₃ (g_{φ2}−g_{φ1}=y−x and g_{φ3}−g_{φ2}=z−y). When the wireless power receiver apparatus 200 is within the range of the wireless power transmitter apparatus 100, the wireless power receiver apparatus 200 will successively answer to the different combinations of signals fₙ and beam patterns Pₖ and will guide the wireless power transmitter apparatus 100 until it delivers z dBm of RF power to the wireless power receiver apparatus 200.

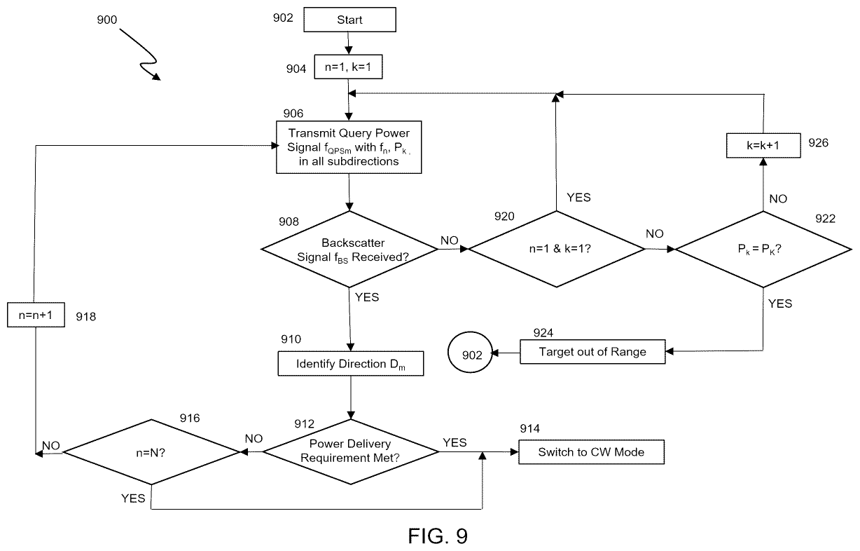

FIG. 9 illustrates an exemplary process flow 900 incorporating aspects of the disclosed embodiments. In this example, an exemplary procedure to deliver the required power to a specific wireless power receiver 200 by using N power query signals f_{QPSn} (n=1, 2, . . . , N) and k (k=1, 2, . . . , K) beam patterns Pₖ with different beam widths φₖ and gain gₖ is illustrated. Although the procedure shown in FIG. 9 is described with respect to sequential scanning, the aspects of the disclosed embodiments are not so limited. In alternate embodiments, any other scanning approach, algorithms or combinations may be used.

At the start at 902 of the process, the initial values for n of the query modulation signal portion fₙ of the f_{QPS} and k for the beam pattern Pₖ are set at 904. In this example, the initial values are n=1 and k=1. The f_{QPS} includes or is associated with a wireless power transfer signal or carrier f_{WPT}, the modulation component or low frequency oscillator signal fₙ and a beam pattern Pₖ. In one embodiment, the f_{WPT} is mixed with fₙ.

In one embodiment, the query modulation signal f₁ for the f_{QPS} and the beam width φ₁ of the beam pattern P₁ can be obtained from the look-up table in the memory 110 of FIG. 2. Generally, the values associated with n=1 and k=1 are such that if there is a target wireless power receiver apparatus 200 within the range or FOV of the wireless power transmitter 100, the target wireless power receiver apparatus 200 will respond or answer to the query power signal f_{QPS} with query modulation signal f₁.

In the first instance, the beam pattern P₁ has the widest beam width of all of the beam patterns Pₖ and a corresponding gain gₖ. The query modulation signal f₁ will generally be associated with a minimum amount of RF power that is received to have a first answer (backscatter signal f_{BS}) from the wireless power receiver apparatus 200. Concurrently with the transmission of the f_{QPS}, an f_{BC} is also transmitted or being transmitted.

In one embodiment, the f_{QPS} with f₁ and P₁ is transmitted at 906. Generally, the f_{QPS} is transmitted in all Dₘ, or D_{m,k}. In one embodiment, one f_{QPS} is transmitted in one direction at a time. FIG. 8A illustrates an example of the f_{QPS} with query modulation signal f₁ being transmitted in all directions.

It is determined or detected at 908 if an f_{BS} is received. The f_{BS} generally comprises the f_{BC} modulated by the fₙ.

If it is determined that the f_{BS} has been received, the Dₘ of the f_{QPS} associated with the received f_{BS} is determined at 910. In one embodiment, Dₘ of the f_{QPS} is known and stored in the memory 108 of FIG. 2.

It is determined at 912 if a power delivery requirement of the wireless power receiver is met. If the wireless power receiver is receiving the required amount of power to operate, the wireless power transmitter apparatus can switch at 914 to the CW mode for wireless power delivery.

If it is determined at 912 that the power delivery requirement is not met, it is determined at 916 whether n is equal to N, where N is the last available fₙ. When n does not equal N, the value of n is increased at 916 to n+1. The f_{QPS} with fₙ, where n=n+1, is transmitted at 906. Thus, in the example where n=1, the next fₙ is f₂. In one embodiment, the RF power associated with query modulation signal f₂ is higher than the RF power associated with query modulation signal f₁. The beam pattern P₁ in this example does not change.

If it is determined at 916 that n=N, in one embodiment, this generally indicates that wireless power receiver apparatus 200 is receiving the required amount of power. In one embodiment, the power delivery requirement and fₙ=f_{N} have the same meaning. The wireless power transmitter 100 can switch at 914 to CW mode of operation.

If it is determined at 908 that the f_{BS} is not received, in one embodiment, it is determined at 920 if n=1 and k=1. If yes, the f_{QPS} continues to be transmitted at 906 with query modulation signal f₁ and beam pattern P₁. Since the wireless power receiver apparatus 200 is in an energy depleted state, it cannot initiate a wireless power charge request. Thus, in this example, the wireless power transmitter apparatus 100 is configured to continue the querying process at 906 until a wireless power receiver apparatus 200 in need of charge comes into range of the wireless power transmitter apparatus 100.

If it is determined at 920 that one or more of n is not equal to 1, or k is not equal to 1, it is determined at 922 whether the beam pattern Pₖ=P_{K}, where K is the narrowest beam width of the beam patterns available. If k-K, meaning that the f_{QPS} has been transmitted with the narrowest available beam pattern P_{K}, the target wireless power receiver apparatus is determined at 924 to be out of range of the wireless power transmitter apparatus. In one embodiment, when it is determined at 924 that the target wireless power receiver apparatus 200 is out of range, the wireless power transmitter apparatus can resume or start at 902 the process 900. In this manner, the wireless power transmitter apparatus 100 is configured to continue the process 900 until a wireless power receiver apparatus 200 in a depleted energy state comes into range of the wireless power transmitter apparatus 100.

In one embodiment, during CW operation at 914, from time to time, the wireless power receiver 200 shall send an “alive” signal to the wireless power transmitter apparatus 100. If the “alive” signal is not received by the wireless power transmitter apparatus 100 within a predefined time window, this generally indicates that the wireless power receiver apparatus 200 is no longer in range or that it moved to a new position and it no longer can collect enough RF power to operate.

If so, a reset is triggered and a new detection/scanning is performed, such as that described above with respect to FIG. 9. The “alive” signal may be transmitted by a dedicated communication module if available, or it can be transmitted by the backscatter module 204 of the wireless power receiver device 200 by driving an external signal 418 to the backscatter switch T₁. This external signal can be generated by a low power microcontroller or any other controlled oscillator and can be connected to T₁, as shown in FIGS. 4 and 5. As described herein, during CW operation, the backscatter module 204 is free for other purposes and it may be used to transmit the “alive” signal.

The aspects of the disclosed embodiments enable the wireless power transmitter apparatus 100 to select a specific target wireless power receiver apparatus 100. For that, the wireless power transmitter apparatus 100 may use additional query power signals f_{QPSn} and f_{QPSn+1} which are pulsed at specific frequencies fₙ that match the desired wireless power receiver apparatus 200.

For example, a first wireless power receiver apparatus, such as a humidity sensor, may use query modulation signals f₁, f₂ and f₃, and a second wireless power receiver apparatus, such as a temperature sensor, may use query modulation signals f₄, f₅ and f₆ and so on. By transmitting an f_{QPS} with specific fₙ, the wireless power transmitter apparatus 100 is able to target the desired wireless power receiver apparatus 200.

The aspects of the disclosed embodiments enable a rapid identification of an energy depleted wireless power receiver apparatus that cannot otherwise initiate signaling to request wireless power. The receiver can re-use the power query signals to provide the answer to the transmitter with zero latency. As soon as the remote apparatus receives a certain amount of energy, which is much lower than the energy used to keep it fully functional, it will instantaneously inform the transmitting system about its presence and if it is collecting at least a certain amount of RF power. There is no processing associated with the feedback mechanism.

The transmitter may also iteratively adjust the beam pattern based on the received feedback until it delivers the required amount of power to the remote power receiver. The aspects of the disclosed embodiments enable a fast selection of the best beam pattern and beam direction to transmit wireless energy towards a specific power receiver without trying every possible beam direction.

Thus, while there have been shown, described and pointed out, fundamental novel features as applied to the exemplary embodiments thereof, it will be understood that various omissions, substitutions and changes in the form and details of apparatus and methods illustrated, and in their operation, may be made by those skilled in the art without departing from the spirit and scope of the present disclosure. Further, it is expressly intended that all combinations of those elements, which perform substantially the same function in substantially the same way to achieve the same results, are within the scope of the disclosure. Moreover, it should be recognized that structures and/or elements shown and/or described in connection with any disclosed form or embodiment of the disclosure may be incorporated in any other disclosed or described or suggested form or embodiment as a general matter of design choice. It is the intention, therefore, to be limited only as indicated by the scope of the claims appended hereto.

What is claimed is:

1. A system, comprising:
a wireless power transmitter configured to:
transmit a query power signal;
receive a backscatter signal from a wireless power receiver;
transmit, when the backscatter signal indicates that a wireless power delivery requirement of the wireless power receiver is not met, a next query power signal associated with a first received RF power that is higher than a second received RF power associated with the query power signal; and
deliver, when the backscatter signal indicates that the wireless power delivery requirement is met, wireless power to the wireless power receiver.

2. The system of claim 1, wherein the wireless power transmitter is further configured to further transmit the query power signal in a plurality of directions.

3. The system of claim 1, wherein the backscatter signal comprises a signal modulated by a query modulation signal component of the query power signal.

4. The system of claim 3, wherein the wireless power transmitter is further configured to determine from the query modulation signal component that a pre-determined amount of radio frequency (RF) power is being delivered to the wireless power receiver.

5. The system of claim 1, wherein the wireless power transmitter comprises a backscatter apparatus configured to:
transmit a backscatter carrier signal when the wireless power transmitter transmits the query power signal; and
detect the backscatter signal.

6. The system of claim 1, further comprising the wireless power receiver, wherein the wireless power receiver is configured to transmit the backscatter signal when an RF power of the query power signal exceeds a first pre-determined power threshold.

7. The system of claim 6 wherein the wireless power receiver comprises a plurality of query power signal receiver paths, wherein the query power signal receiver paths are each associated with a different second pre-determined power threshold, and wherein the wireless power receiver is further configured to transmit the backscatter signal when a power associated with the query power signal exceeds the second pre-determined power threshold.

8. The system of claim 1, wherein the wireless power transmitter is further configured to transmit a next power query signal in sub-directions associated with a direction of the backscatter signal.

9. The system of claim 1, wherein when the wireless power transmitter does not detect the backscatter signal, the wireless power transmitter is further configured to:
change a beam pattern of the query power signal to a next beam pattern, wherein a first beam width of the next beam pattern is narrower than a second beam width of the beam pattern; and
retransmit the query power signal with the next beam pattern.

10. The system of claim 9 wherein the wireless power transmitter is further configured to iteratively narrow the second beam width until the backscatter signal indicates that a required amount of power is being delivered to the wireless power receiver.

11. The system of claim 1, wherein the wireless power receiver further comprises a switching apparatus configured to generate the backscatter signal, and wherein an input sensitivity of the switching apparatus is less than an input power threshold required to power on the wireless power receiver.

12. A method, comprising:
transmitting a query power signal using a wireless power transmitter;
detecting a first backscatter signal from a wireless power receiver in an energy depleted state that indicates that a wireless power delivery requirement of the wireless power receiver is not met;
transmitting a next query power signal associated with a first received RF power that is higher than a second received RF power associated with the query power signal;
detecting a second backscatter signal from the wireless power receiver; and
delivering, when the second backscatter signal indicates that the wireless power delivery requirement is met, wireless power to the wireless power receiver.

13. The method of claim 12, wherein when the first backscatter signal is not detected, the method further comprises:
changing a beam pattern associated with the query power signal to a next beam pattern, wherein a first beam width of the next beam pattern is narrower than a second beam width of the beam pattern; and
transmitting the next query power signal with the next beam pattern.

14. The method of claim 12, wherein the query power signal transmitted by the wireless power transmitter is transmitted in a plurality of directions.

15. The method of claim 12, further comprising calculating from a query modulation signal component that a pre-determined amount of radio frequency (RF) power is being delivered to the wireless power receiver.

16. The method of claim 12, wherein the wireless power transmitter comprises a backscatter apparatus configured to:
transmit a backscatter carrier signal when the wireless power transmitter transmits the query power signal; and
detect the first or second backscatter signal transmitted by the wireless power receiver.

17. The method of claim 12, further comprising transmitting the next power query signal in sub-directions associated with a direction of the first or second backscatter signal.

18. The method of claim 12, further comprising iteratively narrowing a beam width of a beam pattern until a subsequent backscatter signal indicates that a required amount of power is being delivered to the wireless power receiver.

19. A computer program product comprising computer-executable instructions that are stored on a non-transitory computer-readable medium and that, when executed by at least one processor, cause a wireless power transmitter to:
transmit a query power signal;
detect a backscatter signal from a wireless power receiver in an energy depleted state;
transmit, when the backscatter signal indicates that a wireless power delivery requirement of the wireless power receiver is not met, a next query power signal associated with a first received RF power that is higher than a second received RF power associated with the query power signal; and
deliver, when the backscatter signal indicates that the wireless power delivery requirement is met, wireless power to the wireless power receiver.

20. The computer program product of claim 19, wherein the computer-executable instructions, when executed by the at least one processor, further cause the wireless power transmitter to:
change a beam pattern associated with the query power signal to a next beam pattern, wherein a first beam width of the next beam pattern is narrower than a second beam width of the beam pattern; and
retransmit the query power signal with the next beam pattern.
